(19) United States
(12) Patent Application Publication
(10) Pub. No.: US 2017/0066170 A1
(43) Pub. Date: Mar. 9, 2017

(54) INTEGRATED TOOL FOR CREATING AN EMBOSSED KEYBOARD COMPONENT

(71) Applicant: Apple Inc., Cupertino, CA (US)

(72) Inventors: Christopher A. Sandieson, Cupertino, CA (US); Robert S. Murphy, Sunnyvale, CA (US)

(21) Appl. No.: 14/856,795

(22) Filed: Sep. 17, 2015

Related U.S. Application Data
(60) Provisional application No. 62/213,695, filed on Sep. 3, 2015.

(51) Int. Cl. B29C 45/56; B29C 45/37; G06F 3/02; B29C 45/14

(52) U.S. Cl. CPC B29C 45/56; B29C 45/14; B29C 45/372; G06F 3/0202; B29L 2009/00

(57) ABSTRACT

Disclosed herein is an integrated embossing and injection molding tool that is used to overmold a frame on an embossed material. The embossed material and the frame may be used as a keyboard component of keyboard for a portable electronic device.

### CROSS-REFERENCE TO RELATED APPLICATION

This application is a nonprovisional patent application of and claims the benefit of U.S. Provisional Patent Application No. 62/213,695, filed Sep. 3, 2015 and titled “Integrated Tool for Creating an Embossed Keyboard Component,” the disclosure of which is hereby incorporated herein by reference in its entirety.

### FIELD

The described embodiments relate generally to an input component of an electronic device. More specifically, the disclosed embodiments relate to an integrated embossing and injection molding tool that is used to produce an input component having an embossed material portion bonded to a frame portion.

### BACKGROUND

Embossing is a process of creating a raised image, pattern or design on a particular medium. The pattern is typically created on the medium using a combination of heat and pressure. That is, a pattern is created on a plate or a mold that is subsequently heated and pressed to the medium to create the embossed pattern, although in some embodiments the plate or mold may lack any pattern other than a particular size and/or shape. Injection molding is a process in which a component is produced by injecting materials into a mold at a high pressure. However, the pressure and the mold used to create an embossed pattern are often different from the pressure and mold used to create an injection-molded component.

More specifically, for many embossed, injection-molded components or structures, an injection molding tool employs an injection molding process to create a particular component and a separate embossing tool employs an embossing process to create an embossed pattern on the component. As different processes and/or tools are used for the embossed pattern and the injection-molded component, it is difficult to produce an embossed, injection-molded component in a single forming operation.

### SUMMARY

Disclosed herein is a component for an input device of an electronic device. The component is formed using an integrated embossing and injection molding tool. The integrated embossing and injection molding tool creates a pattern or an embossed region on a material. The embossed region may be subsequently bonded to keycap of keyboard or to some other input device. Once the embossed region has been created, an injection molding mechanism of the integrated embossing and injection molding tool molds a frame or other such structure on an unembossed region of the material. As the embossed region and the frame are created by the same tool, the frame is aligned with the embossed region. As a result, the component for the input device may have a desired aesthetic look that could not otherwise be obtained had the embossed region and frame been created by different tools and/or different processes.

More specifically, disclosed herein is an integrated embossing and injection molding tool for forming an input component of an electronic device. The integrated embossing and injection molding tool includes a core having an embossing pattern on a surface. The integrated embossing and injection molding tool also includes a stretching insert for stretching a material placed on the core. An embossing mechanism embosses one or more regions of the material after the material has been stretched by the stretching insert. An injection molding mechanism of the integrated embossing and injection molding tool molds a structure on the material.

For example, using the tool described above, an input component, such as a keyboard component for a keyboard, of an electronic device may be formed. The keyboard component may include a material having an embossed portion and a frame coupled or bonded to an unembossed portion of the material. The frame, or portions thereof, may at least partially surround the embossed portion of the material. As discussed above, the embossed portion and the frame are formed by the same tool.

Also disclosed is a method for forming a keyboard component for an electronic device. This method is utilized by a tool that includes a core, a stretching insert, an embossing mechanism, and an injection molding mechanism. According to this method, the material is stretched or otherwise made taut on the core using the stretching insert. An embossed region (or regions) is formed on the material using the embossing mechanism. A frame may also be molded onto the material using the injection molding mechanism.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an example frame and a material have various embossed regions that may be created by an integrated embossing and injection molding tool;

FIG. 1B shows a combination of the frame and the embossed material of FIG. 1A that may be created by the integrated embossing and injection molding tool;

FIG. 2A illustrates an exploded view of various components of the integrated embossing and injection molding tool;

FIG. 2B illustrates the combination of some of the components of the integrated embossing and injection molding tool of FIG. 2A;

FIG. 2C illustrates a material being coupled to one of the components of the integrated embossing and injection molding tool of FIG. 2A;

FIG. 3 illustrates a cross-section view of an integrated embossing and injection molding tool;

FIG. 4 illustrates a cross-section close-up view of a portion of the integrated embossing and injection molding tool of FIG. 3 in a first position;

FIG. 5A illustrates a cross-section close-up view of a portion of the integrated embossing and injection molding tool of FIG. 3 in a second position;

FIG. 5B illustrates a partial, expanded cross-section view of the portion of the integrated embossing and injection molding tool of FIG. 5A;

FIG. 6A illustrates a cross-section close-up view of a portion of the integrated embossing and injection molding tool of FIG. 3 in a third position;

FIG. 6B illustrates a partial, expanded cross-section view of the integrated embossing and injection molding tool of FIG. 6A;

FIG. 7 is a flow chart that describes a method for creating an embossed material having a frame structure; and

FIG. 8 illustrates an example electronic device that may use or incorporate an embossed component (such as a keyboard or other input mechanism) produced by a sample integrated embossing and injection molding tool.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure is directed to an integrated embossing and injection molding tool (hereinafter referred to as “the tool” or “the integrated tool”). More specifically, the tool described herein integrates an injection molding mechanism with an embossing mechanism to create an embossed, injection-molded component in a single process. For example, the embossing mechanism of the tool is used to create a pattern, an embossed region or feature and the like on a material. Once the embossed region has been created on the material, the injection molding mechanism of the tool overmolds and bonds a frame or other such structure on the material.

As used herein, the term “overmold” or “overmolded” refers to a process of creating a feature out of plastic, resin or polymer on a material, a structure or other feature. For example, the frame that is created by the tool may be overmolded onto, adjacent and/or within the embossed region. Additionally or alternatively, the embossed region may be molded by the embossing mechanism. For example, the embossing mechanism may use a compression molding process that applies heat and pressure to the material to mold the embossed region.

As will be explained in more detail below, the material is placed on a mold that is associated with or is part of the tool. The material is flattened by a moveable insert of the tool. The material is subsequently stretched using a material stretching insert of the tool. More specifically, the material stretching insert creates tension on the material, or on a region of the material, that will be embossed by the embossing mechanism. Once the material has been flattened and stretched, the embossing mechanism applies heat and pressure to the material to form one or more embossed regions.

The embossed region may be used to cover, abut or house an input component of an input device. For example, a keycap for a key of a keyboard may be coupled or bonded to a raised surface of the embossed region of the material, thereby forming a fabric input device or key. In order to provide structural support for the fabric input device, an injection molding mechanism forms a support structure on the material. In some implementations, the injection molding process bonds the support structure on to one or more unembossed regions of the material.

More specifically, the tool described herein also includes an injection molding mechanism. The injection molding mechanism is used to overmold a structure or frame on the material once the embossed region has been created. In some implementations, the injection molding mechanism may overmold the structure or frame on an unembossed region of the material adjacent the embossed region. In another implementation, the injection molding mechanism may overmold a structure or frame on a portion of the embossed region or over the embossed region.

Because the frame is overmolded to the material while the material is being embossed (or after the material has been embossed), and because the tool includes both the embossing mechanism and the injection molding mechanism, the process of creating an embossed, injection-molded component is more streamlined than it would be if the component was formed by separate tools and separate processes. In addition, combining the embossing mechanism and the injection molding mechanism helps ensure that the frame is aligned with the embossed region on the material. As a result, the component may have a higher aesthetic quality and better durability than could otherwise be obtained if the embossed region was produced by a first tool or process, the frame was created by a second tool or process and the parts were subsequently combined.

The embossed, injection-molded component created by the integrated tool may be used in a variety of manners. As described above, the component may be used as part of (or as) an input device for an electronic device.

For example, a fabric keyboard may be produced by bonding various keycaps to the embossed regions on the material. The frame may be bonded to the unembossed regions of the material to provide structural support for the keyboard and each key. In another example, the component may be used as part of a button or other such input mechanism. Although components for electronic devices are specifically mentioned, the tool, and the various components and structures described herein, may be used in a variety of products and be used for a variety of purposes.

The use of the term “embossed” does not imply or require any particular method for forming a corresponding feature or area. Rather, an embossed area, feature or the like may be formed using heat forming, molding, stamping, crimping, weaving, or the like. Some embossed areas or structures discussed herein have one or more sidewalls connecting one or more raised regions to a lower region; such sidewalls may be generally perpendicular to one of or both the raised and lower regions, although this is not necessary.

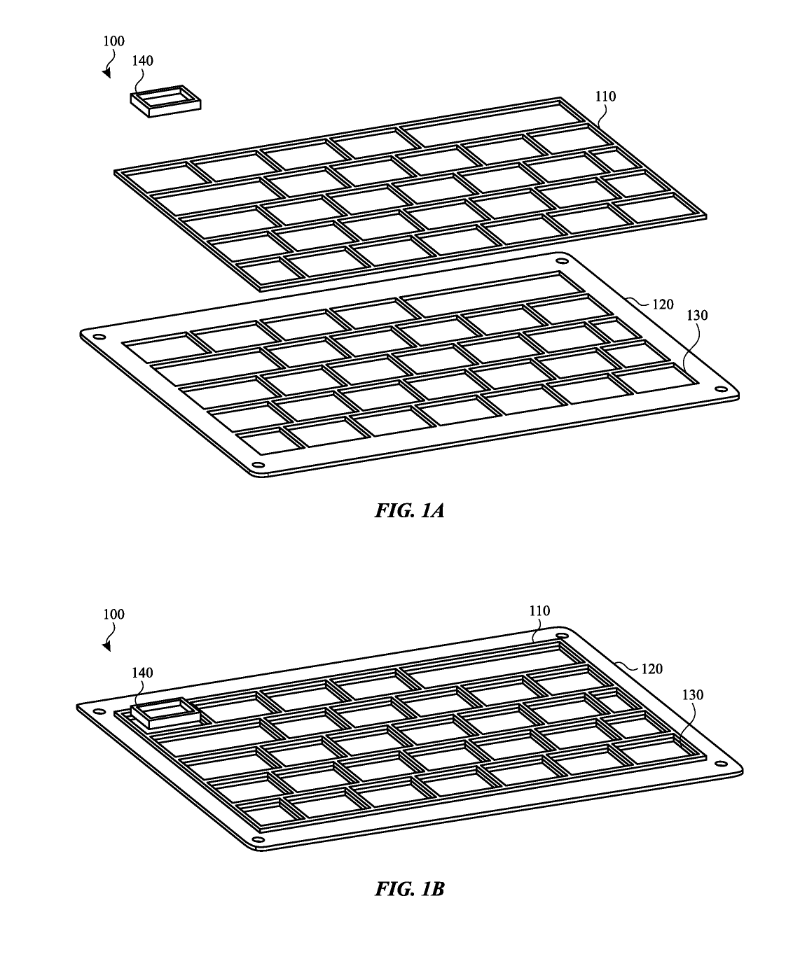

FIG. 1A shows an exploded view of an example component 100 of an input device according to one or more embodiments of the present disclosure. The component 100 includes a frame 110 bonded or otherwise coupled to a material 120. The material 120 may be a woven or non-woven material. For example, the material 120 can be a fabric such as a cloth, a textile and the like. In a more specific yet non-limiting example, the material 120 may be nylon, polyester, elastane and the like although other types of materials may be used.

The material 120 may include one or more embossed regions (also referred to herein as “embossed feature” 130) and one or more unembossed regions. The embossed feature 130 is formed using an embossing mechanism. In various implementations, the embossed feature 130 may include a top section and side sections positioned perpendicular or approximately perpendicular, to the top section. The embossed feature 130 may have a depth and a shape equivalent or substantially equivalent to the shape and depth of an embossing feature disposed on the embossing mechanism. The embossing mechanism may use a combination of heat and/or pressure, or any other compression molding technique, to create the embossed feature 130.

The frame 110 is created using a molding mechanism such as, for example, an injection molding mechanism. The injection molding mechanism creates the frame 110 using a pressure that is different from the pressure used to create the embossed feature 130, even though the embossing mechanism and the injection molding mechanism are integrated into a single tool.

The frame 110 may be bonded to the unembossed region of the material 120. As such, the each portion of the frame 110 may have a shape that outlines, surrounds, is contained at least partially within or otherwise corresponds to the shape of each embossed feature 130. More specifically, frame 110 may have various ribs or support structures that cooperate to define apertures. Each aperture can receive a component (such as a keycap 140) to which each embossed feature is bonded.

To form the frame 110, the injection molding tool may be aligned with a one or more cavities and/or channels in a mold that cause the frame 110 to have a particular shape. For example, if the material 120 includes various embossed features 130, the mold may be designed such that the frame 110, or various portions of the frame 110, may be adjacent one or more edges of one or more of the embossed features 130.

In some implementations, dimensions of each of the apertures in the frame 110 may vary. For example, a first aperture in the frame 110 may have a first set of dimensions to accommodate a keycap 140 of a first size (e.g., a keycap for a letter key of a keyboard) while a second aperture in the frame 110 may have a second set of dimensions to accommodate a keycap of a second size (e.g., a keycap for a shift key, an enter key and the like). In addition, each aperture in the frame 110 may be sized relative to a corresponding embossed feature 130 on the material 120. For example, each aperture may have dimensions that correspond to dimensions of the embossed feature 130 to enable the aperture, or portions of the aperture, to surround, be contained within or otherwise be adjacent to the embossed feature 130.

More specifically and as shown in FIG. 1B, when the frame 110 is bonded to the unembossed regions of the material 120, each aperture in the frame 110 is adjacent to each embossed feature 130 on the material 120. As a result, the frame 110 may provide structural support for each embossed feature 130 and the component 100.

As briefly discussed above, the component 100 may be used as part of an input device, such as, for example, a keyboard for an electronic device. In such an implementation, the component 100 may be placed over one or more keycaps 140 of a keyboard. In another implementation, a keycap 140 may be bonded to a portion of the embossed feature 130. For example, the keycap 140 may be bonded to the top section of the embossed feature 130, one or more side sections of the embossed feature 130 or a combination thereof. In another embodiment, the injection molding mechanism may overmold a keycap 140 directly to the embossed feature 130.

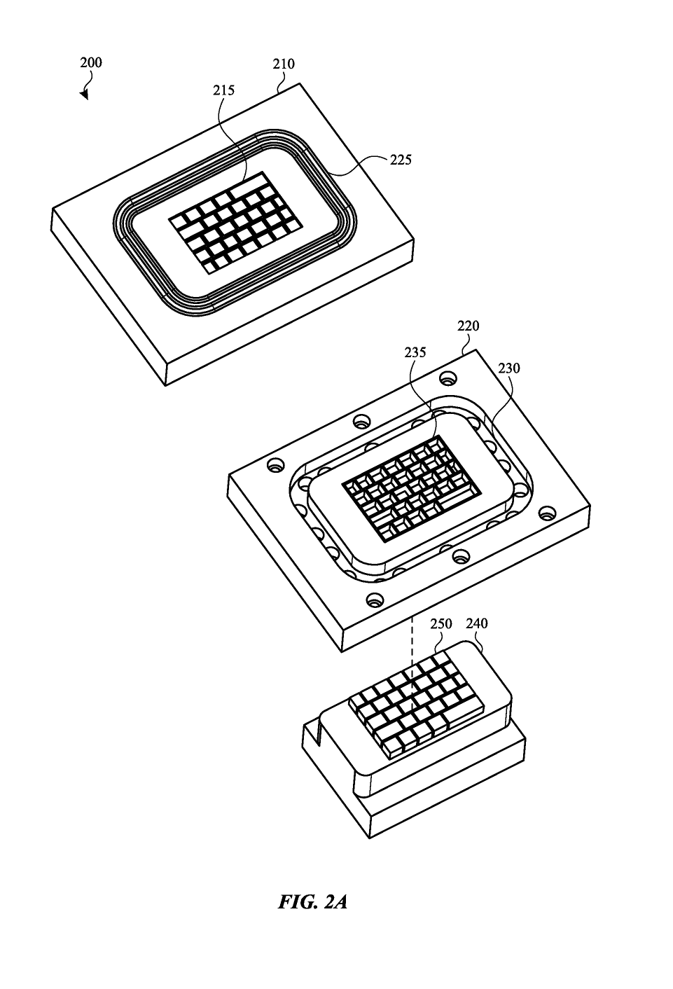

FIG. 2A illustrates an exploded view of various components of an integrated embossing and injection molding tool 200 according to one or more embodiments of the present disclosure. When combined (such as shown in FIGS. 2B-2C), these components may be used to create the component 100 shown and described above with respect to FIGS. 1A-1B.

The tool 200 includes a core 210, a moveable insert 220 and an embossing mechanism 240. Each of these components and their respective functionalities are described in more detail below.

The core 210 is used to create an embossed region (e.g., embossed feature 130 shown in FIG. 1A) on a material. As such, the core 210 includes an embossing pattern 215 surrounded (either entirely or partially) by a channel 225. In some implementations, the embossing pattern 215 may be recessed with respect to a surface of the core 210. In another implementation, the embossing pattern 215 may be raised with respect to a surface of the core 210. In yet another implementation, the embossing pattern 215 may include both raised portions and recessed portions.

The embossing pattern 215 is used in conjunction with the embossing mechanism 240 to create one or more embossed regions on the material. For example and as shown in FIG. 2C, a material 290 is placed on the core 210 and covers the channel 225 and the embossing pattern 215. The material 290 is compressed by the embossing mechanism 240. The embossing mechanism 240 mates with the embossing pattern 215 of the core 210 and pushes the material 290 into the embossing pattern 215 to create the embossed region. Although the embossing pattern 215 is shown and described as part of the core 210, the embossing pattern 215 may be disposed on a surface of the embossing mechanism 240. For example, the embossing pattern 215 may be provided on a surface of the embossing mechanism 240 in lieu of or in addition to the embossing feature 250.

Returning to FIG. 2A, the channel 225 is used to secure the material 290 in place during the embossing and/or the injection molding process. For example, the channel 225 on the core 210 interacts with a material stretching insert 260 (shown in FIG. 2B), to stretch the material 290 prior to the material 290 being embossed by the embossing mechanism 240.

More specifically, the material stretching insert 260 moves relative to the moveable insert 220 and closes on top of the material 290. The material stretching insert 260 also presses the material 290 (e.g., a peripheral portion of the material 290) into the channel 225. As the material 290 is pressed into the channel 225, the material 290 is straightened and/or stretched. For example, the material stretching insert 260 creates tension on the material 290 or on various regions of the material 290 that will be embossed. In some embodiments, the nominal position and the movement of the material stretching insert 260 may be adjustable in order to adjust the tension of the material prior to, during and/or after the stretching process.

In some implementations, the stretching process may change dimensions of the material 290. For example, stretching the material 290 may increase an overall length or width of the material 290. However, changing the dimensions of the material 290 may not affect the dimensions of the region or regions of the material 290 that are embossed.

The core 210 may be constructed of a metal, a plastic or other such material. The core 210 may also include a surface layer or surface texture on the area surrounding the embossing pattern 215 and/or the channel 225. The surface texture may be part of the core 210 itself. In another implementation, the surface texture may be a layer that is added to the surface of the core 210. For example, the surface texture may be a polymer layer that is placed on a surface of the core 210.

The surface texture may be used to position and/or hold the material 290 in place on the core 210 while the material 290 is being flattened by the moveable insert 220 and stretched by a material stretching insert 260 (shown in FIG. 2B and as will be described below). In some implementations, the embossing pattern 215, or portions of the embossing pattern 215, may also include a surface texture. The surface texture on the embossing pattern 215 may be used to provide texture on the embossed region.

As briefly discussed above, the tool also includes a moveable insert 220. The moveable insert 220 is used to flatten and/or position the material 290 (shown in FIG. 2C) on the core 210 once the material 290 has been placed on the surface of the core 210. The moveable insert 220 also includes a channel 230 that receives the material stretching insert 260 (shown in FIG. 2B).

The moveable insert 220 also includes a grid 235. The grid 235 defines a number of apertures that mate with or receive various embossing features 250 on a surface of an embossing mechanism 240. More specifically, the embossing mechanism 240 is moveably coupled to or moveably contained within the moveable insert 220. For example, when the embossing mechanism 240 is contained within the moveable insert 220, each embossing feature 250 on a surface of the embossing mechanism 240 fit within a corresponding aperture in the grid 235. As the moveable insert 220 moves from an open position to a closed position, the embossing mechanism 240 may also move from a first position to a second position. Alternatively, the embossing mechanism 240 may remain in the first position until after the material 290 has been flattened and/or stretched by the moveable insert 220.

Once the material 290 has been flattened, the embossing mechanism 240 may move from the first position to a second position. As it moves from the first position to the second position, the embossing features 250 extend from the apertures of the grid 235 and press the material 290 into the embossing pattern 215 in the core 210. Heat and pressure applied by the embossing mechanism 240 form the embossed features on the material 290.

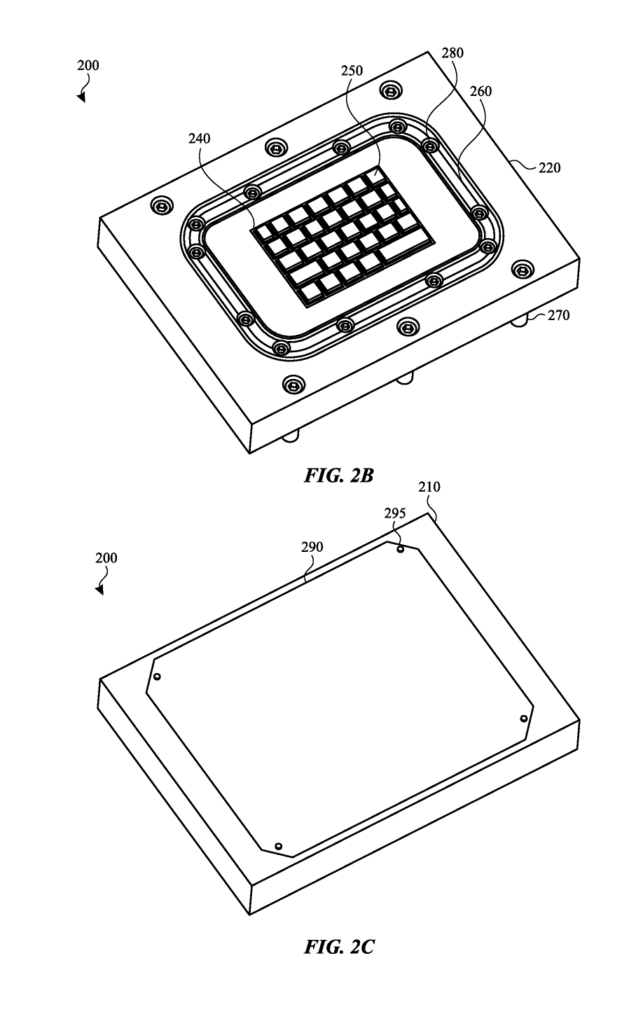

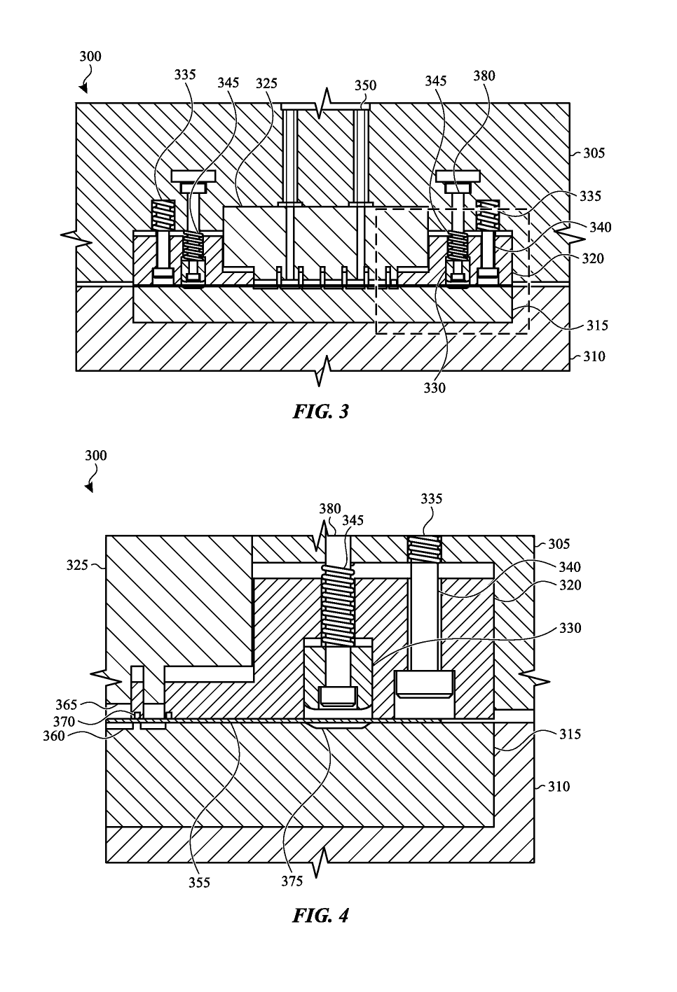

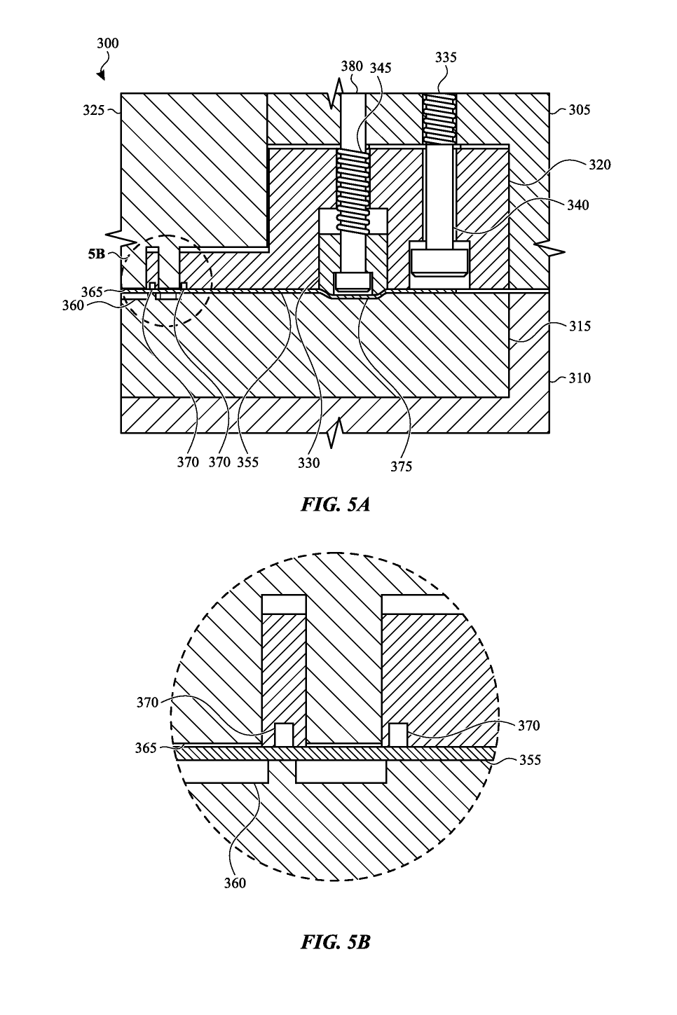

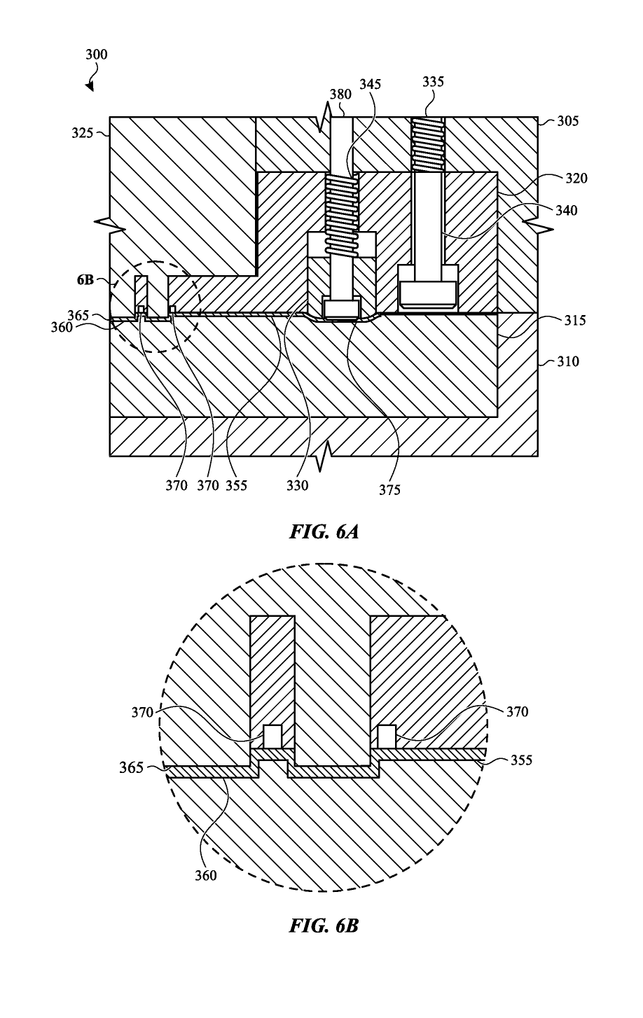

As shown in FIG. 2B, the moveable insert 220 may be slidably coupled to a moveable insert retainer screw 270. The moveable insert retainer screw 270 limits movement of the moveable insert 220 as the plates of the tool move from a first position (or an open position described below with respect to FIGS. 3-4), in which the material 290 can be placed on the core 210, to a second position (or a closed position described below with respect to FIGS. 5A-6B) in which the material 290 is flattened by the moveable insert 220.

As also shown in FIG. 2B, the moveable insert 220 may include a material stretching insert 260. The material stretching insert 260 fits within the channel 230 of the moveable insert 220. Once the moveable insert 220 has moved from the open position to the closed position, a plate of the tool 200 actuates a material stretching insert retainer screw 280 which moves the material stretching insert 260 from its nominal position within the channel 230 to a second position in which the material stretching insert 260 extends from the channel 230.

When the material stretching insert 260 is in the second position, it pushes the material 290 into the channel 225 of the core 210. Stretching the material 290 in this manner helps create a clean or crisp embossed region. Once the material 290 has been stretched, the embossing mechanism 240 is actuated to create the embossed region (e.g., embossed feature 130 shown in FIGS. 1A-1B) on the material 290.

The material stretching insert 260 may be made of a material and/or include grooves, protrusions or other surface features that enables the material stretching insert 260 to secure and/or position the material 290 on the core 210. For example, the material stretching insert 260 may be made of plastic, rubber and/or may be coated with an adhesive to enable the material stretching insert 260 to better grip and/or position the material 290 on the core 210 prior to and during the flattening and/or stretching processes.

In another implementation, the surface texture (e.g., grooves or channels) on the material stretching insert 260 may match or otherwise correspond to one or more surface features (e.g., grooves or channels) in the channel 225 of the core 210. These corresponding features may help retain the material 290 in the channel 225. For example, the surface texture on the material stretching insert 260 and the corresponding surface texture in the channel 225 may act as a clamp to secure the material 290 in place during the stretching process, the embossing process and/or the injection molding process.

FIG. 2C illustrates a material 290 being placed or otherwise secured on the core 210 of the tool 200. As discussed above, the core 210 may have a surface texture that is used to secure the material 290 on the core 210. One or more attachment mechanisms 295 may also be used to secure the material 290 on the core 210. The attachment mechanisms 295 may be apertures that receive corresponding plugs that hold the material 290 in place on the core 210. In another embodiment, the attachment mechanisms 295 may be screws, nails, staples and the like.

FIG. 3 illustrates a cross-section view of an integrated embossing and injection molding tool 300 according to one or more embodiments of the present disclosure. The tool 300 may be used to manufacture the component 100 shown and described with respect to FIGS. 1A-1B. Likewise, the tool 300 may incorporate the components shown and described above with respect to FIGS. 2A-2C.

In the various cross-sections views below, rear walls of the tool 300, as well open spaces between components, are not shown in cross-section for clarity. Likewise, the various actuation mechanisms of the tool 300 (e.g., a material stretching insert retainer screw 380 and a moveable insert retainer screw 340) are also not shown in cross-section for clarity.

The tool 300 is used to create an embossed region on a material and is also used to bond a frame or other structure to the material. The tool 300 may create the embossed region on the material and subsequently overmold the frame or structure around the embossed region. In another embodiment, the tool 300 may create the embossed region and the frame or structure concurrently or substantially concurrently. In yet another embodiment, the embossed region or regions may be created on the material after the structure or frame has been created and bonded to the material.

The tool 300 may include an embossing mechanism 325 and an injection molding mechanism 350. The embossing mechanism 325 may use a first pressure and/or heat to create an embossing feature on a material. On the other hand, the injection molding mechanism 350 may use a second, different pressure when creating the frame or other such structure. As such, the tool 300 is constructed such that the embossing mechanism 325 and the injection molding mechanism 350 each provide appropriate pressure at various times during the manufacturing process to accomplish their respective tasks.

For example, the tool 300 may cause the embossing mechanism 325 to provide heat and pressure to the material at a first time or over a first time period to create an embossing feature. Likewise, the tool 300 may also cause the injection molding mechanism 350 and/or the other components of the tool 300 that assist in the injection molding process to provide a second pressure to the material at a second time or over a second time period to create the structure and bond the structure to the material.

In some embodiments, the tool 300 may be a three-plate design. As such, each plate may perform a different function or actuate a particular component of the tool 300. For example, a first plate may be used to actuate a first component of the tool 300, a second plate may be used to actuate a second component of the tool 300, while the third plate may act to release the component from the tool 300 once the component has been created. In some implementations, each plate may be coupled to or otherwise be included with a main plate 305. However, for purposes of clarity, the additional plates have been omitted from the figures.

In addition to the main plate 305, the tool 300 may include a base plate 310. In an embodiment, both the main plate 305 and the base plate 310 are moveable with respect to one another. In another embodiment, only one plate is moveable with respect to the other.

The base plate 310 may include a core 315. The core 315 may be similar or equivalent to the core 210 described above with respect to FIGS. 2A-2C. For example, the core 315 may include an embossing pattern, a channel and/or a surface texture such as previously described.

More specifically and turning to FIG. 4 (which shows a close-up view of the rectangular box shown in dashed lines in FIG. 3), the core 315 may include an embossing pattern 360. The embossing pattern 360 may be similar to the embossing pattern 215 of FIG. 2A. The embossing pattern 360 may be used to receive a portion of the material 355 when an embossing feature 365 of the embossing mechanism 325 presses the material 355 into the embossing pattern 360.

The core 315 also includes a channel 375. The channel 375 may be similar or equivalent to the channel 225 described above with respect to FIG. 2A. The channel 375 may interact with a material stretching insert 330 of the tool 300. For example, the material stretching insert retainer screw 380 may be actuated to move the material stretching insert 330 and a peripheral portion of a material 355 into the channel 375 in the manner described above.

Referring back to FIG. 3, the tool 300 also includes a moveable insert 320. The moveable insert 320 may be similar to or equivalent to the moveable insert 220 described above with respect to FIGS. 2A-2C. The moveable insert 320, along with the main plate 305, may be configured to move from an open position, in which a material (e.g., material 355 shown in FIG. 4) can be placed into the tool 300, to a closed position in which various regions of the material 355 are embossed and coupled to a frame.

Once the embossed region or regions have been formed from the material 355 and the frame has been bonded to the material 355, the main plate 305 and the moveable insert 320 may be moved from the closed position to an open position to allow the component to be removed from the tool 300.

In order to move the moveable insert 320 from its nominal position to a closed position and vice versa, the tool 300 includes a moveable insert retainer screw 340. The moveable insert retainer screw 340 may be similar to the moveable insert retainer screw 270 shown and described above.

The moveable insert retainer screw 340 may also include a spring 335 that causes the moveable insert 320 to be held in its nominal position. The spring 335 also helps the moveable insert 320 move from the closed position to the open position. For example, when the main plate 305 (or another plate of the system) moves from a closed position to the open position, the spring 335 and the moveable insert retainer screw 340 cause the moveable insert 320 to move from the closed position to the open position. When in the open position, the component manufactured by the tool 300 may be ejected by the tool 300 or otherwise removed from the tool 300.

The tool 300 also includes a material stretching insert 330. The material stretching insert 330 works in conjunction with a material stretching insert spring 345 and the material stretching insert retainer screw 380 to stretch the material 355 once the material 355 has been flattened or pressed by the moveable insert 320. More specifically, the material stretching insert retainer screw 380 and the material stretching insert spring 345 may actuate the material stretching insert 330. Referring back to FIG. 4, as the material stretching insert 330 is actuated, the material stretching insert 330 contacts the material 355 and pushes the material into a channel 375 of the core 315.

Once the material 355 has been stretched, the tool 300 (or a plate of the tool 300) actuates the embossing mechanism 325. When in its nominal position, the embossing mechanism 325, or more specifically, the embossing feature 365 of the embossing mechanism 325, does not extend past an outer surface of the moveable insert 320 such as shown in FIG. 4. When actuated, the embossing mechanism 325, and more specifically the embossing feature 365 of the embossing mechanism 325, moves from its nominal position to a second position such that the embossing feature 365 extends beyond the moveable insert 320 to emboss the material 355.

In some implementations, the pressure of the embossing mechanism 325 may be controlled by one or more plates in the tool 300, one or more springs in the tool 300 or any other actuation mechanism. In addition, the embossing mechanism 325 may also include one or more heating elements and/or cooling elements (not shown). The heating and/or cooling elements may extend through one or more portions of the embossing mechanism regulate the temperature applied to the material 355. These elements may also cool the embossing mechanism 325 once it has finished the embossing process.

Although the embossing mechanism moves or slides relative to the moveable insert 320, the pressure applied to the moveable insert 320 is provided by the main plate 305 while the pressure applied to the embossing mechanism 325 is provided by another actuation mechanism such as previously described. As such, a first pressure may be applied to the embossing mechanism 325 and a second, different pressure may be applied to the moveable insert 320 as needed to accomplish different tasks (e.g., pressing or flattening the material 355 versus embossing the material 355, embossing the material 355 versus injection molding the frame on the material 355).

In some embodiments, the movement of the embossing mechanism 325 may be limited by spring shutoff forces of the various springs in the tool 300. Likewise, the moveable insert 320 may be used to control the thickness of the material 355 and the frame that is overmolded to the material 355.

As will be explained below, the moveable insert 320 may control the thickness of the unembossed regions or portions of the material 355 (e.g., the regions of the material between each embossed region). For example, a gap between the moveable insert 320 and the core 315 can be specified as being half of the thickness of the material, the full thickness of the material and so on. The moveable insert 320 will compress the material 355 until a specified “material gap” has been reached. In some embodiments, the thickness of the unembossed regions of the material 355 may be less than the thickness of the embossed regions (e.g., the thickness of a raised region or a thickness of one or more sidewalls of the embossed region). In other implementations, the unembossed regions of the material 355 may have the same or substantially similar thickness to the embossed region of the material 355.

Referring back to FIG. 3, the tool 300 also includes an injection molding mechanism 350. The injection molding mechanism 350 is used to overmold a frame or other such structure on the material 355. In some implementations, the injection molding mechanism 350 may be inserted though one or more apertures in the embossing mechanism 325 and/or one or more apertures in the moveable insert 320.

For example and referring again to FIG. 4, once the material 355 has been embossed, the injection molding mechanism 350 (shown in FIG. 3) injects material into various mold apertures 370 contained within the moveable insert 320. The mold apertures 370 cause the frame or structure to have a particular shape. For example, material is injected into the mold apertures 370 and the material conforms to the shape, pattern and dimensions of the mold apertures 370.

In an embodiment, the mold apertures 370 are aligned with the non-embossed portions of the material 355. In another embodiment, the mold apertures 370 may be aligned with non-embossed portions of the material 355 and the embossed portions of the material 355. The mold apertures 370 may also be used to overmold one on more keycaps or other structures on the material 355.

In order to more clearly describe the features and functionality of the tool 300, FIGS. 5A-6B illustrate various close-up views (e.g., close up views of the rectangular box shown in dashed lines in FIG. 3) and cutout views of the tool 300 at different stages of the embossing and injection molding processes. For example, FIG. 5A illustrates a close-up view of the integrated embossing and injection molding tool when the tool 300 has moved from an open position, such as shown in FIGS. 3-4, to a second position. More specifically, FIG. 5A illustrates the tool 300 in a state in which the main plate 305 has been closed on the base plate 310 and the moveable insert 320 has been actuated in order to position and flatten the material 355 on the core 315. FIG. 5A also shows the material stretching insert 330 stretching the material 355.

More specifically, when the material stretching insert 330 is actuated, it contacts a peripheral portion of the material and pushes it into the channel 375 of the core 315. As shown in FIG. 5B, although the moveable insert 320 and the material stretching insert 330 are compressing and stretching the material 355, the embossing feature 365 of the embossing mechanism 325 has not yet contacted the material 355.

FIG. 6A illustrates a close-up view of the integrated embossing and injection molding tool 300 of FIGS. 3-4 as it moves from the second position described above to a third position. When in the third position, the embossing mechanism 325 has been actuated in order to form the embossed region on the material 355. More specifically and as shown in FIGS. 6A-6B, the embossing feature 365 on the embossing mechanism 325 pushes portions of the material 355 into the embossing pattern 360 of the core 315.

As discussed above, the embossing mechanism 325 may be configured to apply heat and/or pressure to the portions of the material 355 that are contained within the embossing pattern 360. In some embodiments, the embossing feature 365 may be radiused such that the embossing feature 365 does not bend or otherwise fold corners of the material 355 over each other during the embossing process.

Once the embossing mechanism 325 has created the embossed region on the material 355 (or during the embossing process), the injection molding mechanism 350 may inject material into the mold apertures 370 of the moveable insert 320 to form a frame or structure such as described above.

As also shown in FIG. 6B, the moveable insert 320 may control the material gap of the material 355. For example, pressure applied by the moveable insert 320 on the material 355 may cause the material to be thinner in unembossed region of the material (e.g., a location between the embossed regions) than in another location. That is, the width between the moveable insert 320 and the core 315 is spaced to be half the width of the material 355. Although a gap half as wide as a width of the material is mentioned, gaps with other widths (e.g., widths of the full material, ¾ of the material, ⅓ of the material, and so on) are contemplated.

In some implementations, the material gap may be adjusted based on the size or thickness of the frame that is molded onto the material 355. For example, in order to reduce the thickness of the component, the material 355 may have a gap half the width of the material 355 while the frame may be designed to have a desired thickness. If a more robust component is desired, a gap of the full width of the material may be used with a thicker, more durable frame.

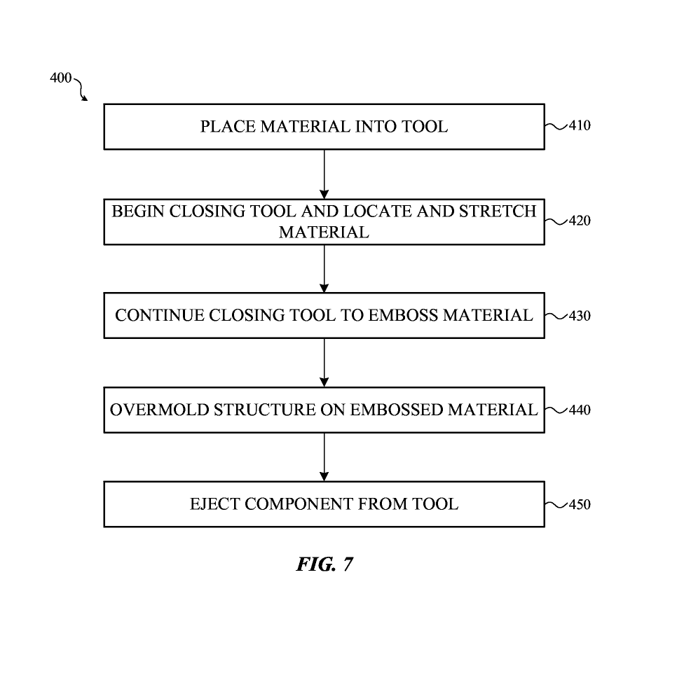

FIG. 7 is a flow chart that describes a method 400 for creating an embossed, injection-molded component according to one or more embodiments of the present disclosure. The method 400 may be used to create the component 100 shown and described above with respect to FIGS. 1A-1B and/or may be used to operate an integrated embossing and injection molding tool such as the tool 300 shown and described above with respect to FIGS. 3-6B.

Method 400 begins at operation 410 in which a material is inserted into the tool. More specifically, the material may be placed on a core or mold of the tool. As previously discussed, the material may be a cloth, a textile, a fabric and the like. In other embodiments, the material may be a metal, a metal alloy or other such material.

Once the material has been inserted into the tool, flow proceeds to operation 420 and the tool begins to close. As the tool closes, a first component of the tool, such as, for example, a moveable insert, positions and flattens the material on the core. As the tool continues to close, a second component (e.g., a material stretching insert) stretches the material.

Once the material is stretched, the tool continues to close to emboss the material 430. The material may be embossed using an embossing feature on an embossing mechanism of the tool. As discussed above, one or more springs of the tool control the amount of pressure provided by the embossing mechanism.

Once the material has been embossed, an injection molding mechanism that is integrated with the tool overmolds a structure on the embossed material 440. In some embodiments, the moveable insert, via a top plate of the tool, applies pressure on the material based on a desired material gap. This pressure also prevents flashing of the injection molding material during the injection molding process.

Flow then proceeds to operation 450 in which the tool is opened and the component (e.g., the embossed material with the overmolded frame) is ejected or otherwise removed from the tool.

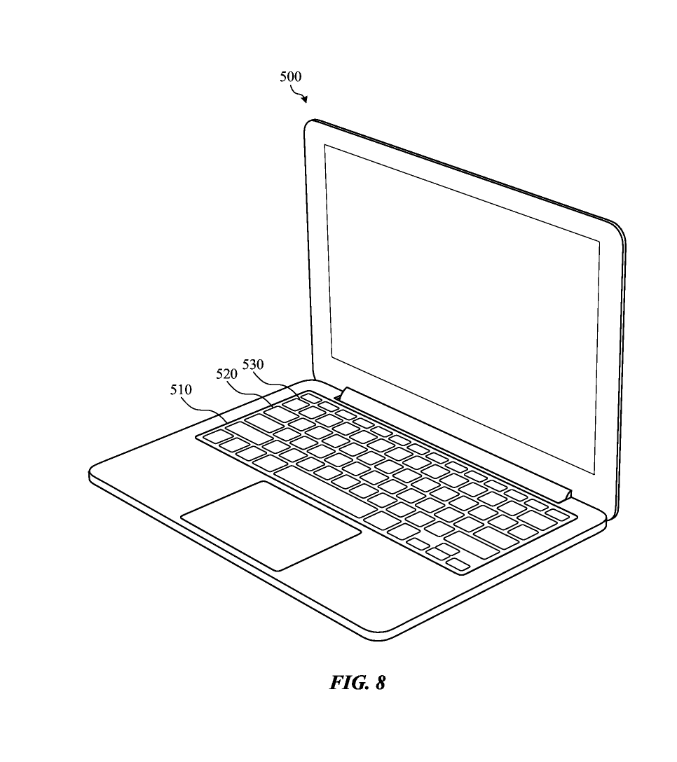

FIG. 8 illustrates an example electronic device 500 that may use a keyboard component produced by the integrated embossing and injection molding tool according to one or more embodiments of the present disclosure. In a non-limiting example, the electronic device 500 may be a laptop computer having an integrated keyboard 510. The keyboard 510 may include various keys 520. Each of the keys 520 may be surrounded by a frame 530 or other support component.

More specifically, the keyboard 510 may be covered in a material having various embossed regions that correspond to each key. A frame 530 may be disposed underneath the keyboard 510 to provide structural support for the keyboard 510. A keycap (not shown) may then be bonded to each embossed region such as described above.

Although a keyboard of an electronic device is specifically shown and described, the tool described herein may be used to create various components having embossed regions and molded structures formed thereon. For example, the tool may be used to create any number of input components such as switches, buttons and the like. In addition, the tool may be used to create a housing for an electronic device or a mechanical device or various other components for these devices.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An integrated embossing and injection molding tool for forming an input component of an electronic device, comprising:
a core having an embossing pattern disposed thereon;
a stretching insert operative to stretch a material placed on the core;
an embossing mechanism operative to emboss the material after the material has been stretched by the stretching insert; and
an injection molding mechanism operative to overmold a structure on the material.

2. The integrated embossing and injection molding tool of claim 1, further comprising a moveable insert to position the material for stretching.

3. The integrated embossing and injection molding tool of claim 2, wherein at least a portion of the embossing mechanism is moveably contained within the moveable insert.

4. The integrated embossing and injection molding tool of claim 2, wherein the stretching insert moves relative to the moveable insert.

5. The integrated embossing and injection molding tool of claim 2, wherein the moveable insert defines one or more apertures operative to form a shape of the structure.

6. The integrated embossing and injection molding tool of claim 1, wherein the stretching insert is adjustable in order to adjust a tension of the material.

7. The integrated embossing and injection molding tool of claim 1, wherein the embossing mechanism has one or more apertures that receive at least a portion of the injection molding tool.

8. The integrated embossing and injection molding tool of claim 1, wherein the core has a surface texture to hold the material in position.

9. The integrated embossing and injection molding tool of claim 1, wherein the embossing mechanism mates with the embossing pattern of the core.

10. The integrated embossing and injection molding tool of claim 1, wherein the injection molding mechanism overmolds the structure on the material after the material has been embossed by the embossing mechanism.

11. A method for forming an input component, comprising:
inserting a material into a tool comprising a core, a stretching insert, an embossing mechanism, and an injection molding mechanism;
stretching the material on the core using the stretching insert;
forming an embossed feature in the material using the embossing mechanism; and
molding a frame onto the material using the injection molding mechanism.

12. The method of claim 11, wherein molding the frame comprises molding the frame adjacent the embossed feature.

13. The method of claim 11, further comprising pressing the material onto the core with a moveable insert prior to stretching the material.

14. The method of claim 11, wherein stretching the material on the core comprises causing the stretching insert to push a peripheral portion of the material into a channel of the core.

15. The method of claim 11, wherein forming the embossed feature in the material using the embossing mechanism comprises causing the embossing mechanism to push one or more portions of the material into a pattern of the core.

16. An input component for an electronic device, comprising:
a material having an embossed portion; and
a frame bonded to an unembossed portion of the material;
wherein the embossed portion and the frame are formed by an integrated tool having an embossing mechanism and an injection molding mechanism.

17. The input component of claim 16, wherein the material is one of a textile, a fabric or a cloth.

18. The input component of claim 16, further comprising a keycap coupled to the embossed portion.

19. The input component of claim 16, wherein the frame is bonded to the unembossed portion of the material by an overmolding process performed by the injection molding mechanism.

20. The input component of claim 16, wherein the unembossed portion has a thickness that is less than the thickness of the embossed portion.
